(19) United States
(12) Patent Application Publication
(10) Pub. No.: US 2016/0272531 A1
(43) Pub. Date: Sep. 22, 2016

(54) PLATE GLASS

(71) Applicant: NIPPON ELECTRIC GLASS CO., LTD., Shiga (JP)

(72) Inventor: Naotoshi INAYAMA, Shiga (JP)

(21) Appl. No.: 14/442,166

(22) PCT Filed: Oct. 11, 2013
(86) PCT No.: PCT/JP2013/077779

§ 371 Date: May 12, 2015

(30) Foreign Application Priority Data
Nov. 13, 2012 (JP) 2012-249314

(51) Int. Cl. C03B 33/08

(52) U.S. Cl. CPC C03B 33/082

(57) ABSTRACT

A glass sheet cut by laser fusing includes a width region on a front surface side and a width region on a back surface side. The width region on the front surface side has a width of 400 μm from a boundary between an end surface formed by cutting and the front surface. The width region on the back surface side has a width of 400 μm from a boundary between the end surface formed by cutting and the back surface. In each of the width region on the front surface side and the width region on the back surface side, a ratio of an area of adhesion of dross having a particle diameter of 2 μm or more with respect to an area of the each of the width region on the front surface side and the width region on the back surface side is 0.01 or less.

### TECHNICAL FIELD

The present invention relates to a glass sheet, and more specifically, to a glass sheet cut by laser fusing.

### BACKGROUND ART

As is well known, in a process of manufacturing glass sheet products to be used for flat panel displays (FPD) such as a liquid crystal display, a plasma display, an electroluminescence display, and an organic light-emitting diode display, for solar cells, and for other electronic devices, a small-area glass sheet is cut out of a large-area glass sheet (mother glass), and an edge portion extending along each side of the glass sheet is trimmed off.

Laser fusing as disclosed in Patent Literature 1 is known as one method of cutting the glass sheet as described above. The laser fusing is a method involving cutting (fusing) an object to be processed, which is as an object to be cut, by irradiating the object to be processed with a laser along a preset cutting line, which extends along a surface of the object to be processed, and by removing a portion molten through heating with the laser.

### CITATION LIST

Patent Literature 1: JP 2000-263277 A

### SUMMARY OF INVENTION

### Technical Problem

Incidentally, in the case where the laser fusing is applied to the cutting of a glass sheet, the following problem arises.

Specifically, the laser fusing of a glass sheet can be performed under various cutting conditions (fusing conditions). In the case of testing the quality of each glass sheet cut under the different conditions by extracting samples from a plurality of glass sheets obtained under the various conditions so as to subject the samples to measurement of strength such as a two-point bending test, there is a significant fluctuation in measurement values depending on the respective conditions even though end surfaces of the samples formed by cutting have substantially the same shape in cross section. Further, some of the samples may not have strength that can withstand the practical use as a product.

For the above-mentioned reason, in the case where the cutting conditions of a glass sheet are changed in a manufacturing line or the like, it is difficult to predict the actual degree of strength of the glass sheet cut after the change in cutting conditions. Thus, under the current circumstances, cutting a glass sheet by laser fusing has a problem from the viewpoint of quality assurance of the glass sheet. Therefore, there is a demand to impart strength, which can stably withstand the practical use as a product, to a glass sheet cut by laser fusing.

In view of the above-mentioned circumstances, it is a technical object of the present invention to impart strength, which can stably withstand the practical use as a product, to a glass sheet cut by laser fusing.

### Solution to Problem

As a result of the earnest study, the inventor of the present invention has found that, even in substantially the same cross-sectional shape of an end surface formed by cutting after laser fusing, minute dross adhering to the end surface, which cannot be observed with naked eyes, influences the strength of the end surface, to thereby achieve the present invention. That is, the glass sheet according to one embodiment of the present invention, which is devised so as to achieve the above-mentioned object, is a glass sheet cut by laser fusing, comprising a width region on a front surface side and a width region on a back surface side, the width region on the front surface side having a width of 400 μm from a boundary between an end surface formed by cutting and the front surface, the width region on the back surface side having a width of 400 μm from a boundary between the end surface formed by cutting and the back surface, wherein in each of the width region on the front surface side and the width region on the back surface side, a ratio of an area of adhesion of dross having a particle diameter of 2 μm or more with respect to an area of the each of the width region on the front surface side and the width region on the back surface side is 0.01 or less. Note that, the “adhesion of dross” as used herein means a state in which the dross adheres to the glass sheet so that the dross cannot easily be separated therefrom, and refers to, for example, a state in which the dross adheres to the glass sheet without being separated therefrom even after the glass sheet is washed with water, alcohol, various detergents, various fluids, or the like.

When the glass sheet is cut by laser fusing, dross adheres to the front surface and the back surface of the glass sheet. It has been found out that, when the dross adheres to the glass sheet, the dross applies a physical shock and a thermal shock to the glass sheet, which is a cause of the formation of cracks therein. As a result, the strength of the glass sheet is decreased. Further, it has been found out that the dross is liable to adhere to the vicinity of an end portion of the glass sheet formed by cutting, and that as the particle diameter of the dross is larger, the dross applies a more significant shock to the glass sheet, and as the number of pieces of the dross is larger, the dross causes the formation of a larger number of cracks. In view of the above, the inventor of the present invention has found that, in the case where, in the each of the width region on the front surface side and the width region on the back surface side of the glass sheet, the ratio of the area of the adhesion of the dross having the particle diameter of 2 μm or more with respect to the area of the each of the width region on the front surface side and the width region on the back surface side is calculated, the strength of the glass sheet can be roughly determined in a suitable manner, and that in the case where this ratio is set to 0.01 or less, the glass sheet can stably withstand the practical use as a product. Note that, the strength that can withstand the practical use as a product is set to 100 MPa or more.

In the above-mentioned glass sheet, it is preferred that the ratio be 0.0035 or less.

In this case, the physical shock and the thermal shock applied to the glass sheet due to the adhesion of the dross become smaller. Therefore, the number of cracks to be formed in the glass sheet can be suppressed, and the decrease in strength of the glass sheet is also similarly suppressed. With this, the glass sheet is enabled to withstand the practical use more stably. Note that, in this case, the strength of the glass sheet cut by laser fusing was able to be set to 200 MPa or more.

In the above-mentioned glass sheet, it is preferred that the ratio be 0.001 or less.

Also in this case, for the same reason as in the above-mentioned case, the glass sheet is enabled to withstand the practical use more stably. Note that, in this case, the strength of the glass sheet cut by laser fusing was able to be set to 230 MPa or more.

In the above-mentioned glass sheet, it is preferred that the glass sheet have a thickness of 500 μm or less.

In the case where the dross adheres to each of a thick glass sheet and a thin glass sheet, as long as the particle diameter of the adhering dross is the same, the length (size) of a crack in a thickness direction formed in each of both the glass sheets is the same. For this reason, in the case where the dross adheres to the glass sheet, as the thickness is smaller, the ratio of the length of the crack to the thickness is larger, and the adverse influence of the crack on the glass sheet increases. Therefore, the strength of the glass sheet tends to decrease. However, the glass sheet according to the one embodiment of the present invention can stably withstand the practical use as a product as long as the ratio of the area of adhesion of the dross is 0.01 or less, even when the thickness is small. As a result, as the thickness of the glass sheet is smaller, the effect of the present invention can be exhibited in a more suitable manner. In this case, the thickness of the glass sheet is more preferably 200 μm or less, most preferably 100 μm or less.

### Advantageous Effects of Invention

As described above, according to the one embodiment of the present invention, it is possible to impart the strength, which can stably withstand the practical use as a product, to the glass sheet cut by the laser fusing.

### BRIEF DESCRIPTION OF DRAWINGS

FIG. 1 is a perspective view illustrating a laser fusing apparatus to be used for manufacturing a glass sheet according to an embodiment of the present invention.

FIG. 2a is a plan view illustrating a front surface of a cut glass sheet.

FIG. 2b is a bottom view illustrating a back surface of the cut glass sheet.

FIG. 3 is a vertical sectional front view illustrating another laser fusing apparatus to be used for manufacturing the glass sheet according to the embodiment of the present invention.

FIG. 4 is a side view illustrating a mode of a two-point bending test of a glass sheet according to an example of the present invention.

FIG. 5 is a graph showing results of the two-point bending test.

### DESCRIPTION OF EMBODIMENTS

Now, a manufacturing method for a glass sheet according to an embodiment of the present invention is described with reference to the accompanying drawings. Note that, in this embodiment, the case is exemplified in which one of glass sheets obtained by cutting one glass sheet into two glass sheets by laser fusing is manufactured as a glass sheet having strength (100 MPa or more) that can withstand the practical use as a product. Further, in the description below, a “front surface” of the glass sheet refers to a surface on a laser incident side of two flat surfaces of the glass sheet to be subjected to laser fusing, and a “back surface” refers to a surface on a laser output side of the two flat surfaces.

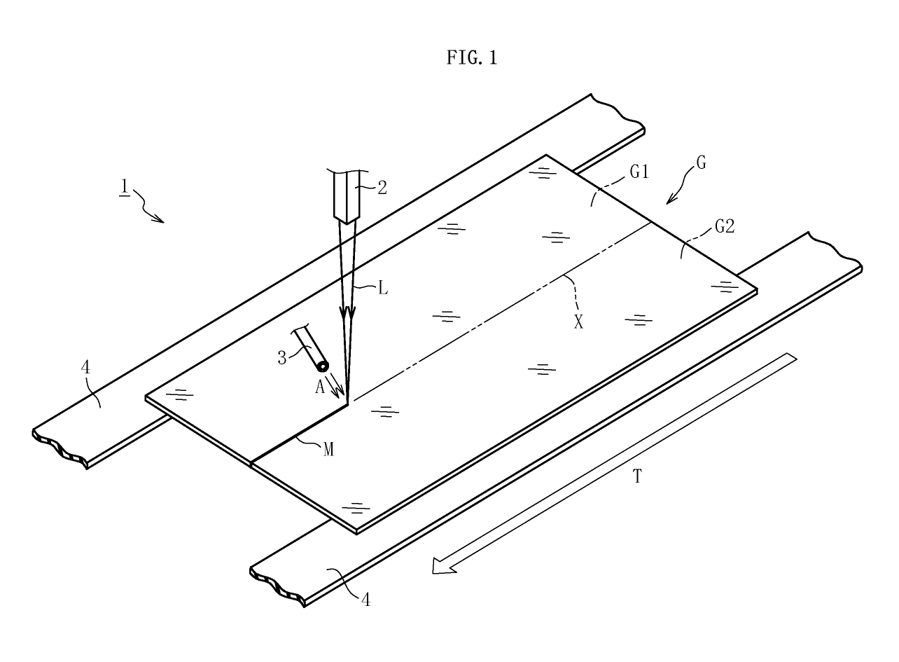

FIG. 1 is a perspective view illustrating a laser fusing apparatus to be used for manufacturing the glass sheet according to the embodiment of the present invention. As illustrated in FIG. 1, a laser cutting apparatus 1 comprises, as main components, conveyor belts 4 for conveying a glass sheet G loaded thereon in a horizontal posture, a laser irradiator 2 for irradiating the glass sheet G with a laser L during conveyance, and an assist gas jetting device 3 for jetting an assist gas A to an irradiation portion of the laser L.

A pair of conveyor belts 4 is arranged across a preset cutting line X extending in the glass sheet G and looped around a driving roller (not shown) and a driven roller (not shown). The conveyor belt 4 is configured to move along a T-direction illustrated in FIG. 1, which is parallel to the preset cutting line X, through the rotation drive of both the rollers.

The laser irradiator 2 is fixed to be installed at a predetermined position so that the preset cutting line X extending in the glass sheet G in parallel to the conveyance direction T passes through a region vertically below the laser irradiator 2. The laser irradiator 2 is configured to condense the laser L oscillated from a laser oscillator (not shown) so as to irradiate the glass plate G with the laser L from the top along the preset cutting line X. Note that, in this embodiment, a carbon dioxide (CO₂) laser (wavelength: 10.6 μm) is used as the laser L.

In this case, as the irradiation condition of the laser L, it is preferred that, when a separation distance from a beam waist (focus position) that is a position at which the light of the laser L is most constricted to a center portion in the thickness direction of the glass sheet G is defined as “s”, and a Rayleigh length is defined as “b”, a value of (s/b) be from 0 to 1.0. The value is more preferably from 0 to 0.5, most preferably from 0 to 0.2. Note that, the Rayleigh length refers to a separation distance in an optical axis direction between two positions at which a beam diameter becomes (√2)d, where d represents a beam diameter in the beam waist.

The assist gas jetting device 3 is fixed to be installed at a predetermined position in the same way as in the laser irradiator 2 and is oriented to the irradiation portion of the laser L in a posture inclined with respect to the front surface and the back surface of the glass sheet G. The assist gas jetting device 3 is connected to an air compression device (for example, an air compressor; not shown) and is configured to jet, as the assist gas A, air compressed by the air compression device to the irradiation portion of the laser L and scatter the glass molten with laser heat by the pressure of the compressed air, to thereby remove the scattered glass. Preferred values of the jetting pressure of the assist gas A are described below. In the case where an inclination angle of the assist gas jetting device 3 with respect to the surfaces of the glass sheet G is more than 30°, it is preferred that the jetting pressure be from 0.01 to 0.5 MPa, and in the case where the inclination angle is equal to or less than 30°, it is preferred that the jetting pressure be from 0.01 to 1.0 MPa. Note that, the jetting pressure as used herein refers to a static pressure in a pipe through which the assist gas A is supplied under a state in which the assist gas A is supplied.

With the above-mentioned configuration, the laser fusing apparatus 1 conveys the glass sheet G loaded on the conveyor belts 4 in the T-direction through the movement of the conveyor belts 4 in the T-direction. Then, the glass sheet G during conveyance is irradiated with the laser L from the laser irradiator 2 along the preset cutting line X so that glass is molten with the laser heat, and the molten glass is scattered so as to be removed by the pressure of the assist gas A jetted from the assist gas jetting device 3. Thus, a fused portion M is caused to propagate in the glass sheet G along the preset cutting line X, to thereby cut the glass sheet G.

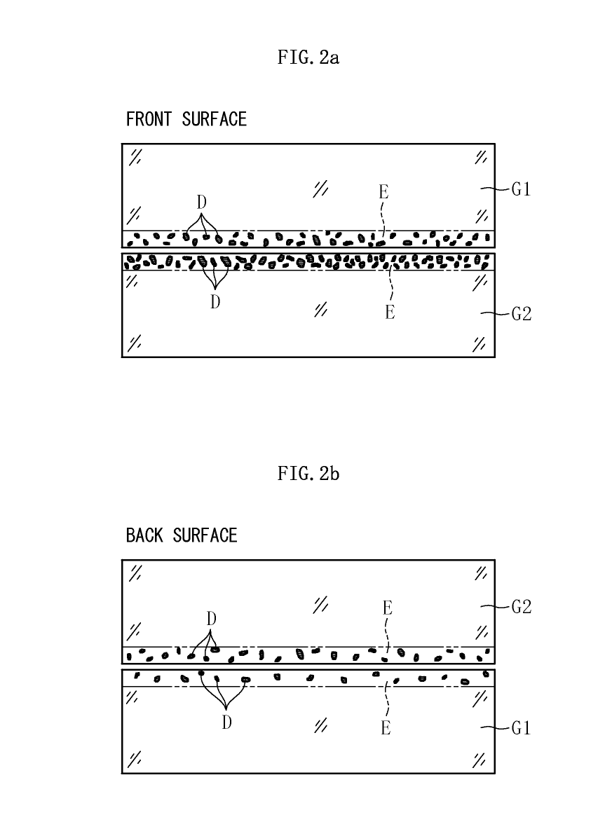

When the glass sheet G is subjected to laser fusing by the laser fusing apparatus 1, the glass sheet G having a large area is cut into two glass sheets each having a small area, specifically, a glass sheet G1 and a glass sheet G2. In this case, dross D scattered at a time of laser fusing is likely to be scattered to a jetting destination side of the assist gas A due to the pressure of the assist gas A. Therefore, as illustrated in FIGS. 2a and 2b, on the front surfaces and the back surfaces of the glass sheets G1 and G2, the adhesion amount of the dross D is larger on the glass sheet G2 positioned on the jetting destination side of the assist gas A than on the glass sheet G1 positioned on a jetting source side. Note that, in FIGS. 2a and 2b, the size (amount) of the dross D is expressed in a more exaggerated manner than in actuality.

Further, through the irradiation of the laser L under the above-mentioned irradiation condition, the glass sheet G can be cut without causing significant misalignment between the center portion in the thickness direction of the glass sheet G and the beam waist. Therefore, when the laser fusing is performed, an energy density distribution in the glass sheet G is prevented from becoming unsuitable for cutting, thereby being capable of avoiding such a situation that the ratio of the area of adhesion of the dross D is increased. Further, the jetting pressure of the assist gas A is set within a range of the above-mentioned values, and thus the assist gas A having a high pressure can be prevented from being jetted to the molten glass, which is generated by melting the glass sheet G with the heat of the laser L. With this, the scattering of the molten glass is prevented in a suitable manner, and hence the increase in ratio of the area of adhesion of the dross D can be further suppressed.

In this manner, the glass sheet G1 having strength (100 MPa or more) that can withstand the practical use as a product can be manufactured. The glass sheet G1 comprises a width region E on a front surface side and a width region E on a back surface side, the width region E on the front surface side having a width of 400 μm from a boundary between an end surface formed by cutting and the front surface, the width region E on the back surface side having a width of 400 μm from a boundary between the end surface formed by cutting and the back surface, and in each of the width region E on the front surface side and the width region E on the back surface side, a ratio of an area of adhesion of the dross D having a particle diameter of 2 μm or more with respect to an area of the each of the width region E on the front surface side and the width region E on the back surface side is 0.001 or less. Note that, the description that the dross D adheres to the glass sheet G1 means a state in which the dross adheres to the glass sheet G1 so that the dross cannot easily be separated therefrom, and refers to, for example, a state in which the dross D adheres to the glass sheet G1 without being separated therefrom even after the glass sheet G1 is washed with water, alcohol, various detergents, various fluids, or the like.

In this case, the area of adhesion of the dross D having the particle diameter of 2 μm or more with respect to the area of the width region E is set to be small, and thus the glass sheet G1 is allowed to have the strength that can withstand the practical use as a product. The reason for this as follows.

Specifically, when the dross D adheres to the glass sheet G during cutting, the dross D applies a physical shock and a thermal shock to the glass sheet G (glass sheet G1), which is a cause of the formation of cracks therein. As a result, the strength of the glass sheet G (glass sheet G1) is decreased. In addition, the dross D is liable to adhere to the vicinity of an end portion of the glass sheet G formed by cutting. As the particle diameter of the dross D is larger, the dross D applies a more significant shock to the glass sheet G, and as the number of pieces of the dross D is larger, the dross D causes the formation of a larger number of cracks. Therefore, when the amount of the dross D adhering to the vicinity of the end portion formed by cutting is reduced, the decrease in strength of the glass sheet G (glass sheet G1) caused by the adhesion of the dross D can be suppressed.

Further, as the thickness of the glass sheet G1 to be manufactured is smaller, the effect of the present invention can be exhibited in a more suitable manner. More specifically, as long as the particle diameter of the adhering dross D is the same between the case in which the thickness of the glass sheet G1 is large and the case in which the thickness of the glass sheet G1 is small, the length (size) in the thickness direction of a crack formed in both the glass sheets G1 is the same. For this reason, in the case where the dross D adheres to the glass sheet G1, as the thickness is smaller, the ratio of the length of the crack to the thickness is larger, and the adverse influence of the crack on the glass sheet G1 increases. Therefore, the strength of the glass sheet G1 tends to decrease. However, according to the present invention, the manufactured glass sheet G1 can stably withstand the practical use as a product as long as the ratio of the area of adhesion of the dross D is 0.01 or less. As a result, as the thickness of the glass sheet G1 is smaller, the effect of the present invention can be exhibited in a more suitable manner. Note that, the above-mentioned ratio of the area of adhesion of the dross D is more preferably 0.0035 or less, still more preferably 0.001 or less.

Note that, the manufacturing method for a glass sheet according to the present invention is not limited to the mode described in the above-mentioned embodiment. For example, although a carbon dioxide laser (wavelength: 10.6 μm) is used as the laser in the above-mentioned embodiment, a carbon dioxide laser (wavelength: 9.4 μm), an ArF excimer laser (wavelength: 193 nm), or the like may be used instead. Also in the case where those lasers L are used, the above-mentioned value of (s/d), the preferred value of the jetting pressure of the assist gas A, and the inclination angle of the assist gas jetting device 3 with respect to the surfaces of the glass sheet G are similar to those in the case where the carbon dioxide laser (wavelength: 10.6 μm) is used.

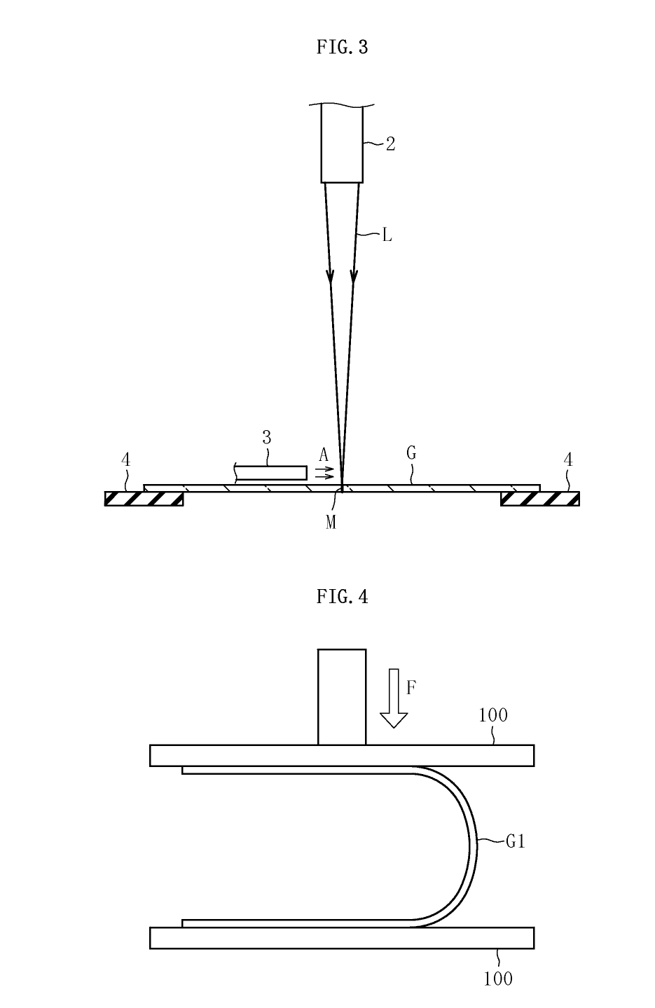

Further, in the above-mentioned embodiment, the assist gas jetting device is installed so as to be oriented to the irradiation portion of the laser in a posture inclined with respect to the front surface and the back surface of the glass sheet in the laser fusing apparatus. However, in addition to this, as illustrated in FIG. 3, the assist gas jetting device may be installed so that the jetted assist gas A passes through the irradiation portion of the laser L in parallel to the front surface of the glass sheet. Note that, in this case, it is preferred that the separation distance between a jetting port of the assist gas jetting device 3 and the irradiation portion of the laser L be from 1 to 30 mm, and that the jetting pressure of the assist gas A be from 0.01 to 1.0 MPa. According to this mode, the jetted assist gas A passes through a region immediately above the molten glass without being directly jetted thereto, and hence the increase in ratio of the area of adhesion of the dross D is further suppressed. This effect becomes more remarkable as the inclination angle of the assist gas jetting device 3 with respect to the front surface of the glass sheet G is smaller. For this reason, the glass sheet G1 positioned on the jetting source side of the assist gas A can be manufactured as a glass sheet having strength that can withstand the practical use as a product.

Further, in the above-mentioned embodiment, the laser fusing is performed while the jetting of the assist gas as well as the irradiation of the laser is performed. However, it is not necessarily required to jet the assist gas, and the irradiation of the laser alone may be performed. Note that, also in this case, the above-mentioned preferred value of (s/d) is similar to that in the case where the assist gas is jetted. In addition, the “irradiation of the laser alone” as used herein encompasses the case considered to be substantially equivalent to the state in which the assist gas is not jetted, specifically, the case where the jetting pressure of the assist gas is 0.01 MPa or less. With this, both the glass sheets obtained by cutting one glass sheet into two glass sheets by laser fusing can be manufactured as glass sheets having strength that can withstand the practical use as a product.

Further, the glass sheet according to the present invention can be manufactured by controlling the ratio of the area of adhesion of the dross to 0.01 or less through the procedures 1 to 7.
1. Control and measurement of a thickness of a glass sheet to be cut (processed) and a cutting speed (processing speed) thereof
2. Control of an appropriate focus position
3. Control of an appropriate laser output
4. Setting of an inclination angle of the assist gas jetting device with respect to the surfaces of the glass sheet
5. Setting of a separation distance between the jetting port of the assist gas jetting device and the irradiation portion of the laser
6. Control of an appropriate jetting pressure of the assist gas
7. Feedback of a cross-sectional shape in an end surface after cutting and a ratio of the area of adhesion of the dross

### EXAMPLE

As an example of the present invention, there was used a glass sheet cut by laser fusing, comprising a width region on a front surface side and a width region on a back surface side, the width region on the front surface side having a width of 400 μm from a boundary between an end surface formed by cutting and the front surface, the width region on the back surface side having a width of 400 μm from a boundary between the end surface formed by cutting and the back surface. In each of the width region on the front surface and the width region on the back surface, a ratio of an area of adhesion of dross having a particle diameter of 2 μm or more with respect to an area of the each of the width region on the front surface side and the width region on the back surface side was calculated, and the relationship between the ratio and the strength (bending strength) of the glass sheet was tested.

The conditions for conducting the test are described below. First, a plurality of different cutting conditions were set with respect to a method of calculating the above-mentioned ratio, and then a plurality of glass sheets cut by laser fusing under each condition were prepared. Then, a glass sheet was extracted at random from the plurality of glass sheets obtained under each condition. The extracted glass sheet was calculated for the above-mentioned ratio regarding both the front surface side and the back surface side, and the calculated values were defined respectively as the ratio on the front surface side and the ratio on the back surface side under each condition. Next, a method of measuring bending strength was performed as follows. The above-mentioned plurality of glass sheets were equally divided under each condition so as to be used for measuring the bending strength on the front surface side and measuring the bending strength on the back surface side. Then, all the plurality of glass sheets obtained under each condition were calculated for the bending strength on the front surface side and the bending strength on the back surface side as described below. As illustrated in FIG. 4, each glass sheet G1 was held between two plate-like members 100. After that, the upper plate-like member 100 was caused to descend until the glass sheet G1 was broken, and the bending strength on the surface side and the bending strength on the back surface side of each glass sheet G1 were calculated based on the interval between the two plate-like members 100 at a time when each glass sheet G1 was broken by a pressure-bending force F. Then, an average value was calculated from the respective bending strengths calculated from the plurality of glass sheets with respect to both the front surface side and the back surface side, and the resultant average values were defined as the bending strength on the front surface side and the bending strength on the back surface side of the glass sheets under each condition.

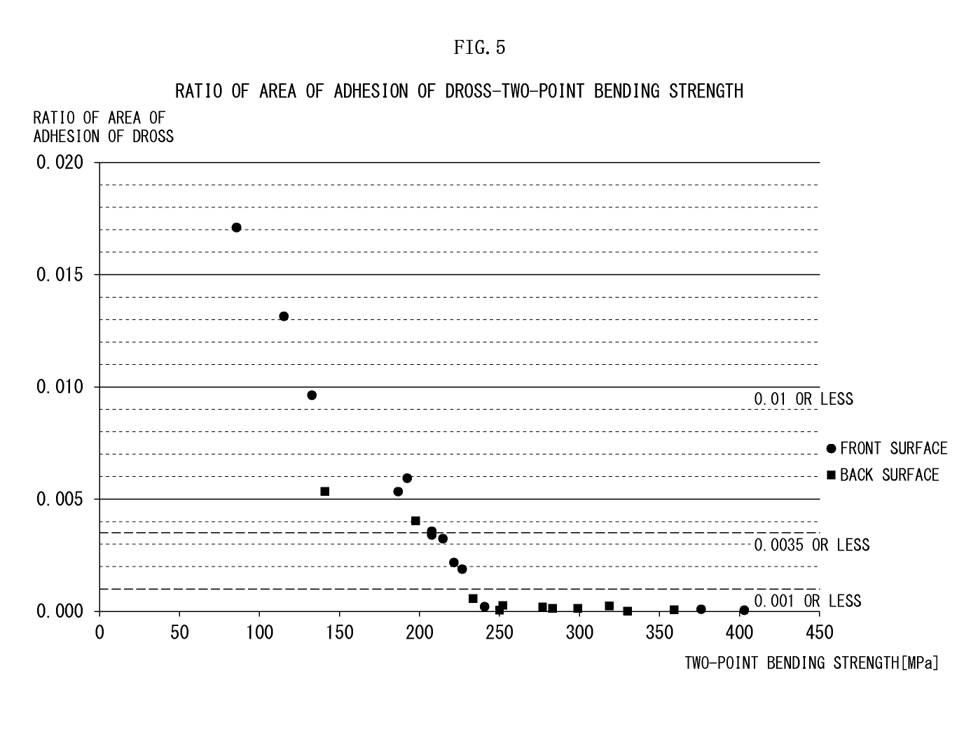

FIG. 5 shows test results. As shown in FIG. 5, the glass sheets having the above-mentioned ratio of 0.01 or less have a bending strength of 100 MPa or more, which can withstand the practical use as a product. Further, the glass sheets having the ratio of 0.0035 or less have a bending strength of 200 MPa or more, and the glass sheets having the ratio of 0.001 or less have a bending strength of 230 MPa or more. It is understood from those results that, when the ratio of the area of adhesion of the dross having the particle diameter of 2 μm or more with respect to the area of the width region is set to 0.01 or less in the glass sheet cut by laser fusing, the glass sheet can stably withstand the practical use as a product. It is also understood that, when the ratio is set to 0.0035 or less or 0.001 or less, the glass sheet can withstand the practical use more stably.

### REFERENCE SIGNS LIST

1 laser fusing apparatus

2 laser irradiator

3 assist gas jetting device

4 conveyor belt

G glass sheet

G1 cut glass sheet

G2 cut glass sheet

D dross

L laser

A assist gas

X preset cutting line

M fused portion

T movement direction of conveyer belt (glass sheet)

100 plate-like member

F pressure-bending force

1. A glass sheet cut by laser fusing, comprising a width region on a front surface side and a width region on a back surface side, the width region on the front surface side having a width of 400 μm from a boundary between an end surface formed by cutting and the front surface, the width region on the back surface side having a width of 400 μm from a boundary between the end surface formed by cutting and the back surface,
wherein in each of the width region on the front surface side and the width region on the back surface side, a ratio of an area of adhesion of dross having a particle diameter of 2 μm or more with respect to an area of the each of the width region on the front surface side and the width region on the back surface side is 0.01 or less.

2. The glass sheet according to claim 1, wherein the ratio is 0.0035 or less.

3. The glass sheet according to claim 2, wherein the ratio is 0.001 or less.

4. The glass sheet according to claim 1, wherein the glass sheet has a thickness of 500 μm or less.

5. The glass sheet according to claim 2, wherein the glass sheet has a thickness of 500 μm or less.

6. The glass sheet according to claim 3, wherein the glass sheet has a thickness of 500 μm or less.
